(19) United States
(12) Patent Application Publication
(10) Pub. No.: US 2006/0261745 A1
(43) Pub. Date: Nov. 23, 2006

(54) Power ring extension cord system

(76) Inventor: Martin M. Beitler, New York, NY (US)

Correspondence Address: LADAS & PARRY, 26 WEST 61ST STREET, NEW YORK, NY, 10023, US

(21) Appl. No.: 11/130,953

(22) Filed: May 17, 2005

(51) Int. Cl. H05B 39/00

(52) U.S. Cl. 315/185 R

(57) ABSTRACT

An easily assembled interior and exterior electrification system for trees or other structural elements allows for considerable versatility of design and display options varying from simple decoration to signage and street address, for example, and easy disassembly for storage has a split ring having electrical power outlets spaced about the split ring for supplying electrical power and a cord having a connection to the split ring for supplying electrical power to the electrical power outlets.

### BACKGROUND OF THE INVENTION

This invention relates to an extension cord system and, more particularly, a method for providing electric power in trees or indoor or outdoor structural elements, for example, to provide ornamental lighting in trees, informational material lighting under overpass constructions, or temporary lighting about building sites as may be called a power ring electrification system.

The illumination of trees and other structural elements is quite common in western society, specifically during the Christmas holidays but not limited to that application. The present technique is primarily to suspend long strands of lighting end to end in series with one end attached to a current source and the other blind ending. The problems with this present technique are many and varied. They include older wiring in which the bulbs are in series and even a single blown bulb can lead to the entire strand not lighting, and great difficulty in untangling the long lighting strands while removing them from the tree or from their storage container. Additionally, designs with the present technique are primarily limited to light bulbs pre-arranged by the long strands, which provide little alternative to simply wrapping the strands around the object (e.g., tree branch) to be illuminated, and with no flexibility as to other forms of signage or display media.

More recently, inventors created several types of tree lighting systems. U.S. Pat. No. 5,984,491 (1991) discloses a netlike lighting device which pulls over the tree much as a sock pulls over a foot. This invention is of fixed size, it cannot be individually assembled to fit a given tree or structure, and it is not adaptable to any other type of electrical display such as street number or other holiday decoration. Further, this device can be placed only at the tree's periphery, easily tangles, and can only be used for a tree and not any other structures. Lastly, it is not clear if it can be used out doors and, due to its cumbersome nature, it cannot be easily stored as may be suggested in that no provision is made for a storage mechanism when it is not in use.

U.S. Pat. No. 4,870,547 to Crucefix (1989) discloses a collar that attaches to the top of a tree with lights draping down toward the bottom from their origin at the collar. This invention places the lights only superficially and not wound out from the center, which would add depth to the appearance of the tree and, as a result of the design, creates a density of light much greater at the top of the tree than at the bottom. It is difficult to keep the lights in place and there in no adaptability for displaying other devices or signage. It also has little application or flexibility for use with any other structure besides trees.

U.S. Pat. No. 6,634,766 to Gordon (2003) discloses lighting elements attached to bendable wires which are contoured around tree trunks or other structures. The problems with this device are that once deformed to fit a given structure it is more difficult to attach it to a different structure. The inherent design is carried out specifically to provide the lighting system its own fixed structure which creates redundancy of structure and cumbersomeness of design which in turn limits its adaptability. This device too seems restrictive in use allowing for no specific use for other holiday occasions.

While each of these inventions addresses specific problems, there are still many improvements which are neglected. None of them offer the possibility of use for signage such as building street address designation, or attaching ornaments specific to holidays other than Christmas. Lastly none offers much flexibility of design, ease of application, or ease of disassembly and storage.

### SUMMARY OF THE INVENTION

Therefore, my invention provides a method of providing electrical power in or about a tree or structural element, preferably with a power ring extension cord system of a split ring having electrical power outlets spaced about the split ring for supplying electrical power and a cord having a connection to the split ring for supplying the electrical power to the electrical power outlets. Preferred embodiments may also include further elements as described below.

Several objects and advantages of the preferred embodiments of the present invention are to provide a safe, easy, and reliable mechanism to:

(a) provide electricity to a tree or other similar structure;

(b) provide an anchoring mechanism or power ring at multiple levels on said tree or structure;

(c) provide for attachment of electric light strings, electric ornaments, electric lettering, or additional light strings off of each power ring which can be laid atop, wound around, or suspended from said structure or tree;

(d) provide a variety of specifically designed lighting elements, ornaments, lettering, and signage for display;

(e) provide a device which is assembled, disassembled, and stores with relative ease and speed; and

(f) provide a simple and durable storage container for said invention.

Further objects and advantages are to provide a lighting system which is easily assembled and conveys electrical access securely to multiple sites on the structure to be electrified. It allows great flexibility of design layout and sophistication with penetration of lighting deeper into the structure being electrified. Because of multiple sites of attachment for lighting strands many more colors and types of lighting can be used in a particular configuration or design rather than in predetermined long strands as in the prior art creating the opportunity for much more diversity in design.

Because the light strands contain female plug receptacles as well as light bulbs electrified ornaments, letters, and other devices can be displayed significantly increasing the capability of the power ring system.

Additionally, the system is specifically crafted to allow for ease of assembly, disassembly, and storage. Because the light strands are shorter they are much less likely to tangle or break and therefore will last longer.

In accordance with these embodiments, I have designed a simpler and more versatile means of electrically decorating trees and other structures. It allows ease of application, multiple types of lighting and decoration, and ease of disassembly and storage. My invention also provides significant advantages over the prior art involving tree decoration and illumination as has been and will be further demonstrated herein.

### BRIEF DESCRIPTION OF THE DRAWING

Preferred embodiments will now be described with reference to a drawing that illustrates but does not limit them, in which:

FIG. 1 is top/front perspective schematic view simplified to show only some features of a first embodiment;

FIG. 2 is a partial elevational view of the first embodiment of FIG. 1 rotated clockwise and enlarged to show some of the features better and to include others;

FIG. 3 is a top plan view of a portion of second embodiment in a closed condition; and

FIG. 4 is a top plan view of the portion of the second embodiment of FIG. 3 in an open condition.

### DESCRIPTION OF PREFERRED EMBODIMENTS

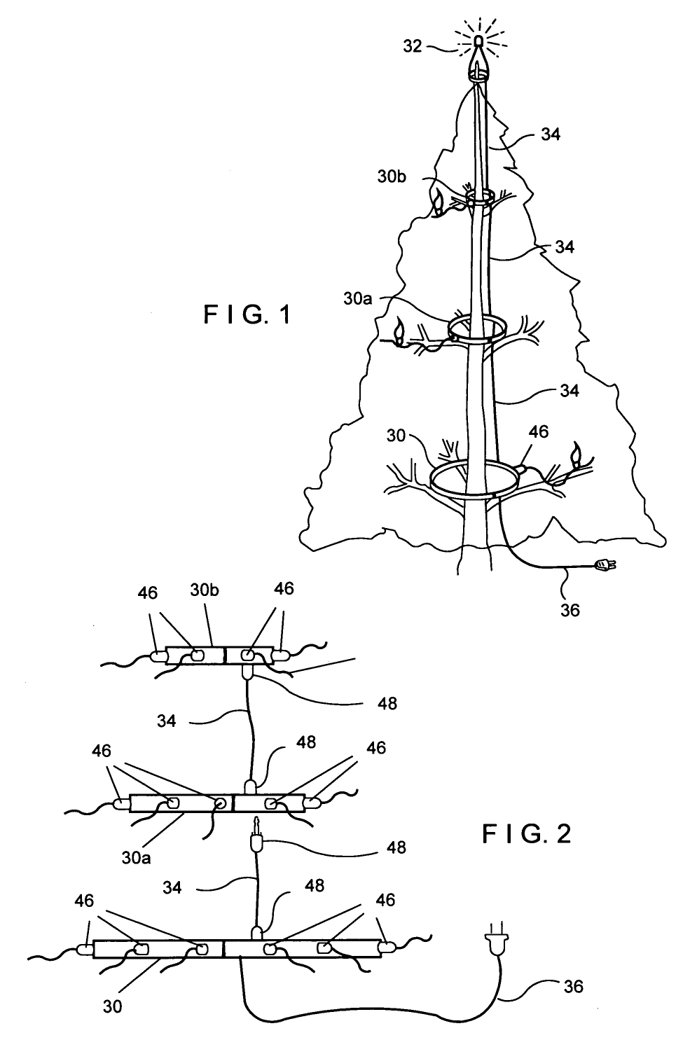

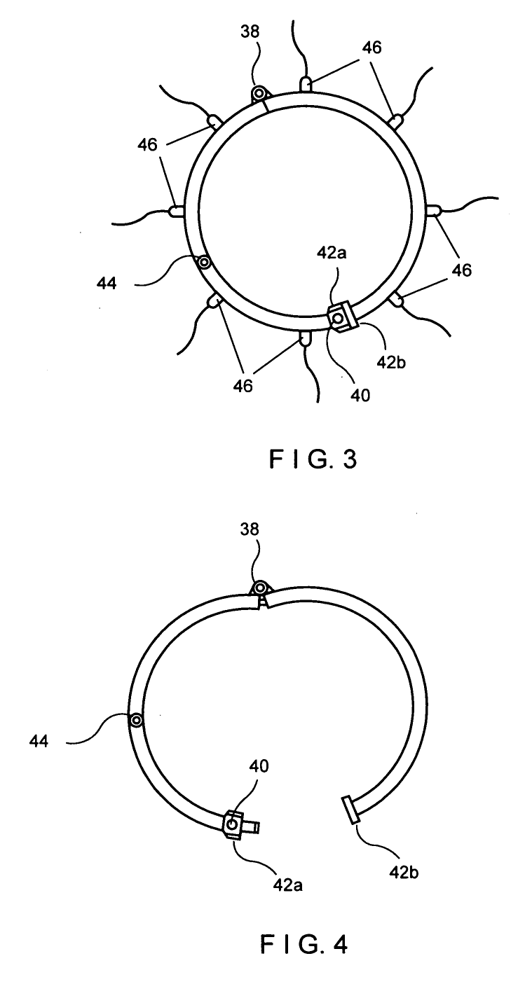

A preferred system shown in FIGS. 1 and 2 has split power rings 30, 30a and 30b in graduated sizes. The largest power ring 30 is fixed to a cord 36 for supplying electrical power to conventional electrical inlets/outlets (not shown) spaced about the power ring for receiving the power plugs of strings of lights. The other poser rings 30a and 30b are similar, except that their power-supplying cords 34 have plugs 48 for inlet/outlet connection to the rings, the plugs and complementary inlets/outlets 44 (FIGS. 3 and 4) being of a known co-axial style that is non-compatible with the other conventional electrical inlets/outlets. This limits the power rings substantially to connection to each other for some control over or suggestion of the maximum current flow through the system and/or the provision of fusing in the plugs 48, for example, for safety.

The split power rings 30, 30a, 30b each have only one substantially axial split 31, 31a, 31b. Opening of the rings to surround a tree trunk as shown in FIG. 1, for example, is then accomplished by spreading and/or twisting the split power rings, for which reason these rings have resilience or other shape-retaining property. Other embodiments (not shown) may have helically split power rings, for example.

One or more of the split power rings 30, 30a, 30b, like the ring 30b in this embodiment, may be connected to a crown ornament 32 or, for example, signage (not shown) by a cord 34.

Although this preferred embodiment is shown with graduated power rings as may be suitable for the tree use as shown in FIG. 1, the cords 34 and plugs 48 permit other combinations of power rings. Power rings all of the same size may be more suitable to signage and construction site illumination, for example.

FIGS. 3 and 4 show a power ring of another embodiment with diametrically opposite axial splits. One split has a hinge 38 for opening and closing the ring, and the other split has complementary halves 42a, 42b of a clasp that can be released with a button 40.

Other preferred embodiments of the power ring lighting system of the present invention are not illustrated. They have power rings like 30 of varying size (approximately 4 inches to 12 inches in diameter). Each power ring snaps around the trunk of a tree and is held in place by sitting atop generally horizontal tree branches that project from the trunk. The lower most ring is connected to the power source by a power cord like 36 which attaches to the lower surface of the power ring at the power plug receptacle like 44 with a power plug like 48. Each ring is connected to the next ring up via an inter-connector 34 which plugs into the upper surface of the lower power ring and the lower surface of the upper power ring.

Once set up in the above configuration the tree is electrified allowing for multiple hook-up points or hubs for light strands like 46, crown ornaments like 32, or other specifically designed elements to be connected at multiple height levels or hub locations on the tree or other structure. This allows many options for decoration and display including variations in color, texture, ornament type, and signage.

The hinged power ring as in FIGS. 3 and 4 suggest preferred embodiments of semicircular rigid plastic arcs which connect on one side by a hinge like 38 and on the other side close to make a circle via a clasp like 42 to secure it. Variations of design are possible as are construction materials.

Embedded throughout the outside or inside, top or bottom periphery of the exterior surface at the rings are light strand receptacles into which light strand plugs like 46 are plugged. The receptacles and plugs may be of unique design to avoid possible unintentional misuse by attaching other electrical devices which might create a fire hazard.

The light strands comprehend at least 3 embodiments which are either wholly lights, lights and plug receptacles in different ratios, or wholly receptacles, e.g. electrical outlets. In addition the strands come in a plurality of lengths, for example varying from approximately 6 inches to 6 feet to either hang down or to accommodate different lengths of branches and styles of display (e.g., coiled around branches or laid atop branches). In addition the light strands can be made in a plurality of colors, light configurations, and bulb styles. (An example of a light strand has receptacles and two short branching strands with different sized electrical ornaments at strand ends.)

The manner of using the power ring lighting system will be described for a tree but can be adapted for use on any appropriate structural elements (fences, sign posts, mailbox posts, leaders and gutters, etc.). Once the tree is in place convenient height intervals along the trunk are identified for placement of power rings like 30 (usually 18 to 36 inches apart). The rings are then snapped into place, connected to one another with inter-connectors like 34 and the lower most ring is connected to a power source by a power cord like 36.

Once this has been accomplished the light strands like 46 are chosen and plugged into the appropriate light strand receptacle 46 and are wound around the branches or laid atop them. Following the placement of the light strands the desired shorter light strands and ornaments are plugged in to recepticales, e.g. sockets, along the light strands to achieve the desired design and the decoration process is complete.

If the power ring system is in place for a specific holiday or occasion and not in place for long term use, once the specific use is over the above process is easily reversed. The individual components are quickly and easily stored for future use in containers that may be provided as part of the system, if desired.

From the description above a number of advantages of my power ring electrification system become evident:
(a) It provides a fast and easy way to set up a versatile lighting access system for indoor and outdoor structural elements (fences, posts, leaders and gutters, etc.);
(b) Once set up the invention allows a plethora of design and display options including:

1. Many color options for lighting by strand, allowing for variations from uniform background color to creating a veritable rainbow of colors in specific zones, or patterns (see FIG. 14 for examples);

2. Many secondary strands attached to primary strands create much distinction and visual diversity;

3. Many electrified ornaments in a plurality of sizes and shapes again add to interest, visual diversity, and beauty, and increase the range of use to virtually and holiday or occasion;

4. Many options for displaying letters, numbers, or signage greatly increase the invention's usefulness; and
(c) Ease of disassembly and storage for later use if its application is temporary.
   Accordingly, the reader will see the many advantages of the power ring electrification system has over the prior art. These range from eliminating long tangled light strands to facilitating myriad variations of color, ornamentation, lettering, signage, to ease of assembly, disassembly, and storage. In addition when used outside of homes or places of business the invention can provide display for other holidays: lighted turkeys on Thanksgiving, skeletons and ghosts on Halloween, hearts on Valentines Day, and bunnies on Easter. Even light house street numbers or business names can be displayed. Furthermore, the power ring electrification system has the additional advantages that: there is no tangling of long delicate lighting strands; there is no wasted time in assembly or disassembly; and there are many more design options allowing for year-round use on many occasions. Although the description above contains many specificities, these should not be construed as limiting the scope of the invention but merely providing illustrations of some of the presently preferred embodiments of this invention. For example, the ring structure need not be rigid and the power source and ring system need not be individual components, but might in fact be a long power cord with a plurality of plug receptacles placed at predetermined intervals along its length which is clamped onto the desired structure with some sort supplied clamping device. The central concept consists of a device which provides multiple locations of access to power into which shorter light strands or other ornaments and display devices can be attached and secured in order to improve upon currently available prior art which is difficult to apply and is quite restrictive in application. In addition to the above, combinations, permutations and variations as will also occur to those of ordinary skill in the art are contemplated within the scope of the following claims.

I claim:

1. In a method of providing electrical power in or about a tree or structural element, the improvements comprising:
providing reversibly attachable electrical-outlet hubs for attachment to the tree or structural element when providing the electrical power thereto and reversibly detaching the hubs when not providing the electrical power, whereby to store the hubs for later re-use, each of the hubs having conventional electrical outlets for providing electrical power when the hubs are connected to a source of the electrical power;
providing a supply of the electrical power to a first of the hubs; and
providing the electrical power from the first of the hubs to a next of the hubs,
whereby ornamental lighting strings in the tree or informational material lighting or temporary lighting about the structural element can be plugged into the conventional electrical outlets about the hubs for using the electrical power provided in or about the tree or structural element by the hubs.

2. The method according to claim 1, wherein providing the electrical power from the first of the hubs to the next of the hubs comprises providing a non-conventional outlet or inlet in one of the hubs, the non-conventional outlet or inlet being non-compatible with the conventional electrical outlets.

3. A power ring extension cord system for lighting or electrifying of a tree or other structural element that provides a power supply to multiple sites, levels, or components of said tree or structural element comprising:
a plurality of power rings for securely and reversibly fastening to said tree or other structural element interconnected in series with one another and thence to a power source in order to convey electrical current to a plurality of sites.

4. The power ring extension cord system according to claim 3, wherein:
(a) each of the power rings comprises an insulated rigid plastic circular structure which is of adequate diameter to securely close around the tree or other structural element and remain in place;
(b) said ring contains a plurality of interconnected plug receptacles around its periphery for attachment to lighting elements, additional electric plug receptacles, or a combination of both heretofore referred to as power strings.

5. The power ring extension cord system according to claim 4, and further comprising:
power strings plugged into at least one of the power rings and further attached to or laid upon structural elements and can themselves then provide power to and suspend ornamental or informational display devices, the power strings comprising:
(a) insulated wires with a plurality of one or more of bulbs, electrifiable ornaments, letters, numbers, signs, sound elements, additional plug receptacles, or a combination of both in a linear array and which themselves plug into the power string;
(b) said power strings are of predetermined lengths varying between several inches and several feet.

6. A power ring extension cord system, comprising:
a split ring having electrical power outlets spaced about the split ring for supplying electrical power; and
a cord having a connection to the split ring for supplying electrical power to the electrical power outlets.

7. The power ring extension cord system according to claim 6, wherein at least one of the electrical power outlets is non-compatibly different from another of the electrical power outlets.

8. The power ring extension cord system according to claim 7, wherein the connection of the cord to the split ring includes the one of the electrical power outlets.

9. The power ring extension cord system according to claim 6, wherein the split ring has only one substantially axial split.

10. The power ring extension cord system according to claim 7, wherein the split ring has only one substantially axial split.

11. The power ring extension cord system according to claim 8, wherein the split ring has only one substantially axial split.

12. The power ring extension cord system according to claim 6, wherein the split ring has first and second substantially axial splits, the first of the substantially axial splits having a hinge for opening and closing the split ring.

13. The power ring extension cord system according to claim 7, wherein the split ring has first and second substantially axial splits, the first of the substantially axial splits having a hinge for opening and closing the split ring.

14. The power ring extension cord system according to claim 8, wherein the split ring has first and second substantially axial splits, the first of the substantially axial splits having a hinge for opening and closing the split ring.

15. The power ring extension cord system according to claim 1 2, wherein the second of the substantially axial splits has a clasp for holding the split ring closed.

16. The power ring extension cord system according to claim 13, wherein the second of the substantially axial splits has a clasp for holding the split ring closed.

17. The power ring extension cord system according to claim 14, wherein the second of the substantially axial splits has a clasp for holding the split ring closed.
